(19) United States
(12) Patent Application Publication
(10) Pub. No.: US 2002/0120677 A1
(43) Pub. Date: Aug. 29, 2002

(54) Method and apparatus for using a servlet to interoperate with server pages

(76) Inventors: Philip J. Goward, Portland, OR (US); William J. Leler, Portland, OR (US); Brian Buckn am, Tigard, OR (US)

Correspondence Address: PARK, VAUGHAN & FLEMING LLP, 508 SECOND STREET, SUITE 201, DAVIS, CA, 95616, US

(21) Appl. No.: 09/792,463

(22) Filed: Feb. 23, 2001

(51) Int. Cl. G06F 15/16; G06F 17/30; G06F 15/163

(52) U.S. Cl. 709/203; 707/513; 709/311

(57) ABSTRACT

One embodiment of the present invention provides a system that facilitates using a servlet to execute a server page. This system operates by receiving a request at the servlet, wherein the request is triggered by a client making a reference through a uniform resource locator (URL). In order to service the request, the system selects a server page to execute based upon the request, wherein the server page includes dynamically executable code embedded in a display language. The system then executes the server page by using a method that is accessible within the servlet to execute the server page, so that after execution control automatically returns to the servlet. Executing the server page causes a display page to be displayed on the client.

### BACKGROUND

1. Field of the Invention

The present invention relates to the process of designing applications for web sites on the Internet. More specifically, the present invention relates to a method and an apparatus for providing a servlet that interoperates with server pages in order to implement a web application.

2. Related Art

As the Internet continues to expand at an exponential rate, thousands of new web sites are coming on line every day selling products as diverse as books and automobiles, and offering services, such as stock trading and electronic banking. Unfortunately, deploying a web site of any sophistication can be an expensive and time-consuming proposition, requiring a large investment in expensive programmer time. Furthermore, once a web site is deployed, it is typically expensive to update and maintain.

As web sites become more sophisticated, it is becoming increasingly common to provide web pages that perform computations and other functional operations in addition to simply displaying static information. This is often accomplished by executing “server pages,” which contain dynamically executable code in addition to static display language commands. For example, JAVA™ server pages (JSPs) are extensions to Java servlet technology, developed by SUN Microsystems, Inc. of Palo Alto, Calif. as an alternative to Active Server Pages (ASPs) developed by the Microsoft Corporation of Redmond, Wash. JSPs support dynamic scripting in addition to HyperText Markup Language (HTML) code.

The execution of server pages is often controlled by servlets executing on a web server. Note that a servlet is a program that runs on a server, and which can be executed by another application on the server. Also note that a servlet is typically persistent, which means that once it is started it stays resident in memory, which allows a servlet to fulfill multiple requests from multiple applications.

Unfortunately, controlling the execution of server pages through servlets can be a complicated task. For example, referring to FIG. 3, a servlet typically first receives a request for a page from a client (step 302). Next, the servlet may compute data that is required for the server page (step 304), and then packages the data into a session (step 306). Next, the servlet performs a redirection to the server page which passes control to the server page and causes the server page to execute (step 308). While the server page is executing, it retrieves the packaged data (step 310).

Note that programming this type of system is complicated because code must be explicitly included within the servlet to package the data, and code must be explicitly included in the server page to retrieve the packaged data. Furthermore, note that once execution is redirected to the server page, it is not possible to use methods defined within the servlet without somehow returning control back to the servlet, or alternatively, by replicating the desired functionality within the server page.

What is needed is a method and an apparatus for executing server pages without the above-described complications that arise from packaging and unpackaging data.

Furthermore, what is needed is a method and an apparatus that allows a server page to execute methods defined within a servlet.

### SUMMARY

One embodiment of the present invention provides a system that facilitates using a servlet to execute a server page. This system operates by receiving a request at the servlet, wherein the request is triggered by a client making a reference through a uniform resource locator (URL). In order to service the request, the system selects a server page to execute based upon the request, wherein the server page includes dynamically executable code embedded in a display language. The system then executes the server page by using a method that is accessible within the servlet to execute the server page, so that after execution control automatically returns to the servlet. Executing the server page causes a display page to be displayed on the client.

In one embodiment of the present invention, the method executes the server page by compiling the server page, and then executing the compiled server page to generate the display page. In a variation in this embodiment, executing the compiled server page involves performing one or more callbacks to the servlet in order to utilize state information maintained within the servlet. In a variation on this embodiment, executing the compiled server page involves computing data to be injected into the display page.

In one embodiment of the present invention, the method that is accessible within the servlet is part of a template comprising a persistent object that defines the method.

In one embodiment of the present invention, the system provides a different template instance for each server page that is currently active within the servlet.

In one embodiment of the present invention, the server page is executed within a protected environment defined within the servlet.

In one embodiment of the present invention, the server page is executed outside of a space that the servlet is executed in.

In one embodiment of the present invention, the system facilitates using multiple server pages to create a single display page.

In one embodiment of the present invention, prior to receiving the request at the servlet, the system receives the request from the client at a server. The system then selects the servlet to execute based upon the request, and makes the request of the servlet.

In one embodiment of the present invention, the server page includes one of a Java Server Page (JSP), and an Active Server Page (ASP).

In one embodiment of the present invention, the servlet comprises an application that is executed by a web server.

### BRIEF DESCRIPTION OF THE FIGURES

FIG. 1 illustrates a collection of servers that operate together in accordance with an embodiment of the present invention.

FIG. 2 illustrates how a servlet uses templates to access server pages in accordance with an embodiment of the present invention.

FIG. 3 illustrates the prior art processes involved in using a servlet to access a server page.

FIG. 4 is a flow chart illustrating the process of using a servlet to access a server page through a method invocation in accordance with an embodiment of the present invention.

FIG. 5 illustrates the process of executing a server page in accordance with an embodiment of the present invention.

FIG. 6 illustrates the structure of a servlet and a related server page in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Servers

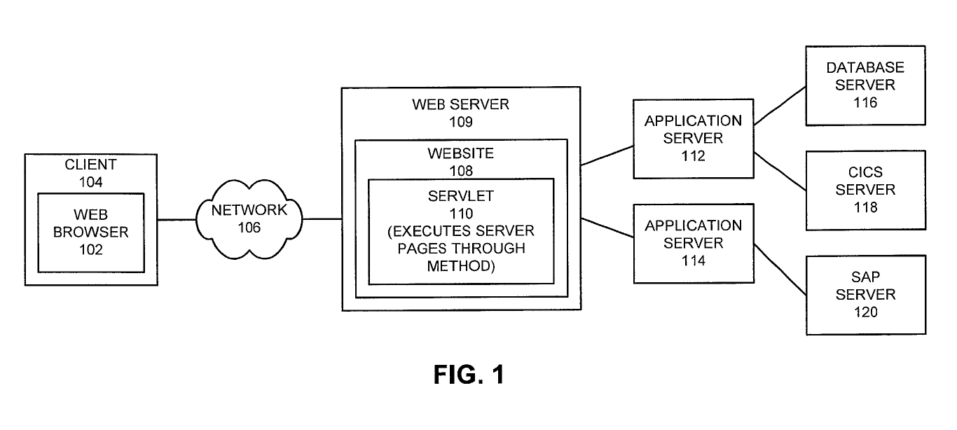

FIG. 1 illustrates a collection of servers that operate together in accordance with an embodiment of the present invention. In FIG. 1, a web browser 102 on client 104 communicates across network 106 with a web site 108 on web server 109.

Client 104 can generally include any node on network 106 including computational capability and including a mechanism for communicating across network 106. Web browser 102 can generally include any type of web browser capable of viewing a web site, such as the INTERNET EXPLORER™ browser distributed by the Microsoft Corporation of Redmond, Wash.

Network 106 can generally include any type of wire or wireless communication channel capable of coupling together computing nodes. This includes, but is not limited to, a local area network, a wide area network, or a combination of networks. In one embodiment of the present invention, network 106 includes the Internet.

Web server 109 can generally include any computational node including a mechanism for servicing requests from a client for computational and/or data storage resources. Web server hosts web site 108, which contains inter-linked pages of textual and graphical information that can be navigated through by a user operating web browser 102. Note that web site 108 contains a servlet 110 that executes a server page by invoking a method that executes the server page.

Web server 109 communicates with application servers 112 and 114 to perform some of the computational operations involved in implementing web site 108. Application servers 112 and 114 can in turn communicate with other servers, such as database server 116, CICS server 118 and SAP server 120, to gather information and/or to perform other computational operations.

Servlet

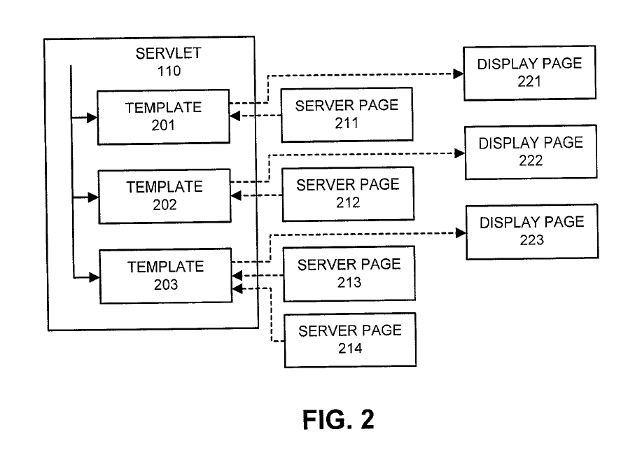

FIG. 2 illustrates how servlet 110 uses templates 201-203 to access server pages in accordance with an embodiment of the present invention. Servlet 110 includes a number of templates 201-203. Templates 201-203 are object instances through which server pages 211-214 can be executed to produce display pages 221-223. These display pages are ultimately outputted through web browser 102 on client 104 (see FIG. 1). Servlet 110 can cause a server page 211 to be executed by invoking a method defined within template 201 that causes server page 211 to be executed. In one embodiment of the present invention, template 201 is implemented as a “bean” defined within the JAVA programming language.

Note that in general the mapping between server pages and display pages need not be one-to-one. For example, it is possible for a single server page to be used to generate multiple display pages, and it is possible for multiple server pages to be used to generate a single display page.

It is also possible for a given template to be selectively associated with different server pages. For example, in FIG. 2, server page 214 can be selectively associated with either server page 213 or server page 214 or both.

Process of Executing a Server Page through a Servlet

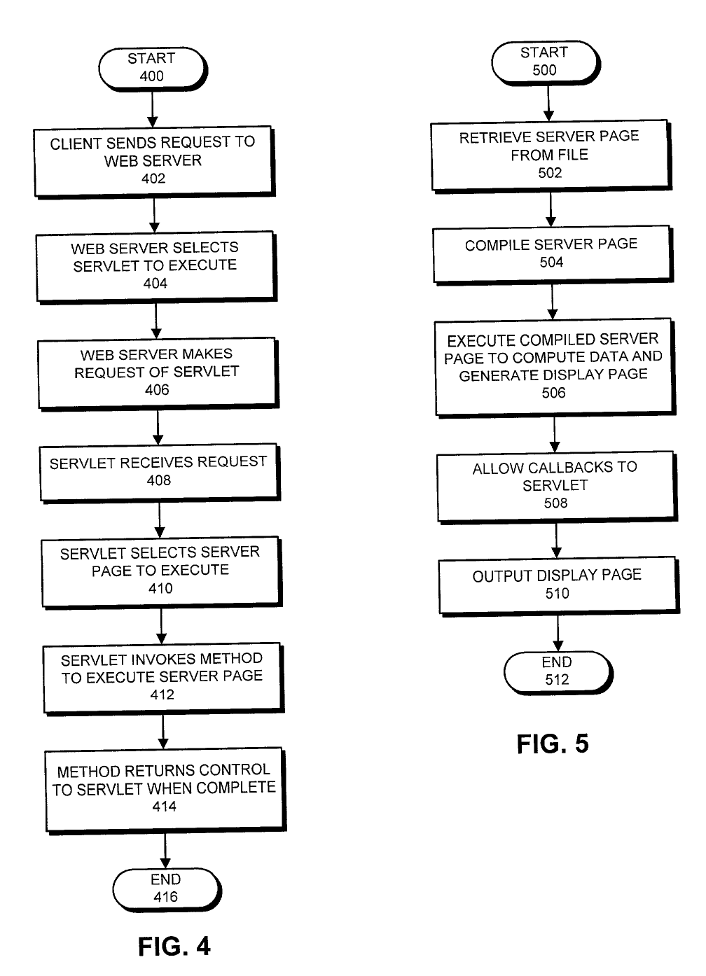

FIG. 4 is a flow chart illustrating the process of using a servlet to access a server page through a method invocation in accordance with an embodiment of the present invention. Client 104 first sends a request through a URL to web server 109 (step 402). Next, web server 109 selects a servlet, such as servlet 110, to execute based upon parameters of the request or other state information (step 404). Note that instead of selecting a servlet, web server 109 may also select a static HTML page, a server page or a graphics file to display.

Once servlet 110 is selected, web server 109 makes a request of servlet 110 (step 406). Upon receiving the request (step 408), servlet 110 selects a server page to execute based on parameters of the request (step 410). For example, servlet 110 may select any one of server pages 211-213 to execute based upon parameters of the request. Servlet 110 then invokes a method defined within an associated template to execute the server page (step 412).

For example, servlet 110 can execute server page 211 by invoking a method defined within template 201. Recall that template 201 can be an instance of an object (or a component) that is accessible from servlet 110. Finally, the method invoked by servlet 110 returns control to servlet 110 after it terminates (step 414). In contrast, note that control is not returned in conventional systems that redirect execution to a server page.

Process of Executing a Server Page

FIG. 5 illustrates the process of executing a server page 211 in accordance with an embodiment of the present invention. The method invocation from step 412 of FIG. 4 causes a number of actions to take place. Server page 211 is first retrieved from its file (step 502), and is compiled into a compiled server page (step 504). Next, the compiled server page is executed to compute any required data values and to generate display page 221 (step 506).

During this execution process, server page 211 can make callbacks into servlet 110 in order to use methods defined within servlet 110, and also to access state information stored within servlet 110 (step 508).

Servlet and Server Page Structure

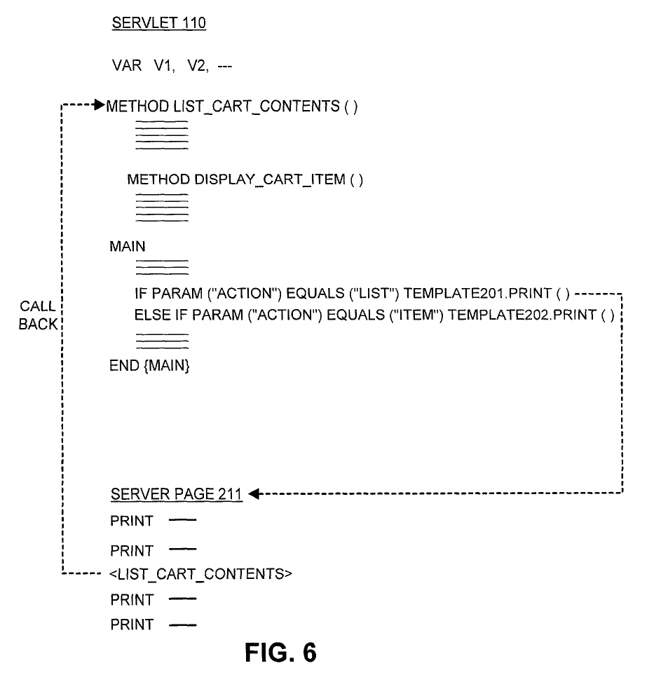

FIG. 6 illustrates the structure of servlet 110 that interacts with a server page 211 in accordance with an embodiment of the present invention. Servlet 110 includes variables v1, v2 . . . , which can be used to store state information. This state information can be accessed by server pages 211 through callbacks to servlet 110. Servlet 110 also includes methods, “list cart_contents” and “display_cart_item,” which can be accessed by server page 211.

Within the main program of servlet 110, if the action parameter for the request equals “list,” a print method within template 201 is called. This print method causes server page 211 to be executed. Note that server page 211 includes HTML markup text, as well as a callback to the method list_cart_contents defined within servlet 110. This callback causes the method list_cart_contents to be executed. Similarly, if the action parameter for the request equals “item,” a print method within template 202 is called, which causes server page 212 to be executed.

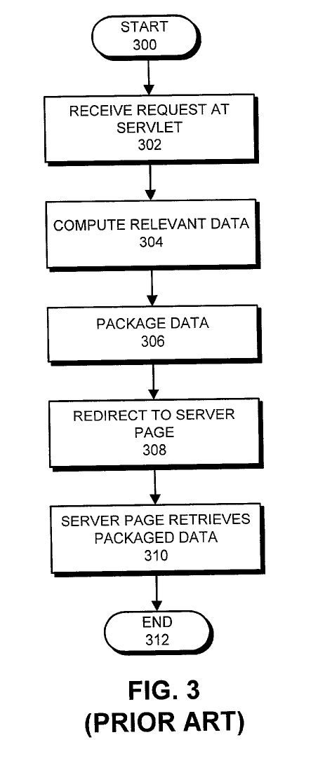

Note that the method list_cart_contents can access variables v1 and v2 defined within servlet 110, if necessary. This eliminates the need for state information to be packaged into a session and then unpackaged for server page 211 as is required in existing systems that perform redirection to server pages (see steps 306 and 310 of FIG. 3).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for using a servlet to execute a server page, comprising:
receiving a request at the servlet, wherein the request is triggered by a client making a reference through a uniform resource locator (URL);
selecting the server page to execute based upon the request, wherein the server page includes dynamically executable code embedded in a display language; and
executing the server page by using a method that is accessible within the servlet to execute the server page, so that after execution control automatically returns to the servlet;
wherein executing the server page causes a display page to be displayed on the client.

2. The method of claim 1, wherein the method executes the server page by:
compiling the server page; and
executing the compiled server page to generate the display page.

3. The method of claim 2, wherein executing the compiled server page involves performing a callback to the servlet in order to utilize state information maintained within the servlet.

4. The method of claim 2, wherein executing the compiled server page involves computing data to be injected into the display page.

5. The method of claim 1, wherein the method that is accessible within the servlet is part of a template comprising a persistent object that defines the method.

6. The method of claim 5, further comprising providing a different template instance for each server page that is currently active within the servlet.

7. The method of claim 1, wherein the server page is executed within a protected environment defined within the servlet.

8. The method of claim 1, wherein the server page is executed outside of a space that the servlet is executed in.

9. The method of claim 1, further comprising using multiple server pages to create a single display page.

10. The method of claim 1, wherein prior to receiving the request at the servlet, the method further comprises:
receiving the request from the client at a server;
selecting the servlet to execute based upon the request; and
making the request to the servlet.

11. The method of claim 1, wherein the server page includes one of:
a Java Server Page (JSP); and
an Active Server Page (ASP).

12. The method of claim 1, wherein the servlet comprises a program running on a server that can be executed by another application running on the server.

13. A computer-readable storage medium storing instructions that when executed by a computer cause the computer to perform a method for using a servlet to execute a server page, the method comprising:
receiving a request at the servlet, wherein the request is triggered by a client making a reference through a uniform resource locator (URL);
selecting the server page to execute based upon the request, wherein the server page includes dynamically executable code embedded in a display language; and
executing the server page by using a method that is accessible within the servlet to execute the server page, so that after execution control automatically returns to the servlet;
wherein executing the server page causes a display page to be displayed on the client.

14. The computer-readable storage medium of claim 13, wherein the method executes the server page by:
compiling the server page; and
executing the compiled server page to generate the display page.

15. The computer-readable storage medium of claim 14, wherein executing the compiled server page involves performing a callback to the servlet in order to utilize state information maintained within the servlet.

16. The computer-readable storage medium of claim 14, wherein executing the compiled server page involves computing data to be injected into the display page.

17. The computer-readable storage medium of claim 13, wherein the method that is accessible within the servlet is part of a template comprising a persistent object that defines the method.

18. The computer-readable storage medium of claim 17, wherein the method further comprises providing a different template instance for each server page that is currently active within the servlet.

19. The computer-readable storage medium of claim 13, wherein the server page is executed within a protected environment defined within the servlet.

20. The computer-readable storage medium of claim 13, wherein the server page is executed outside of a space that the servlet is executed in.

21. The computer-readable storage medium of claim 13, wherein the method further comprises using multiple server pages to create a single display page.

22. The computer-readable storage medium of claim 13, wherein prior to receiving the request at the servlet, the method further comprises:
receiving the request from the client at a server;
selecting the servlet to execute based upon the request; and
making the request to the servlet.

23. The computer-readable storage medium of claim 13, wherein the server page includes one of:
a Java Server Page (JSP); and
an Active Server Page (ASP).

24. The computer-readable storage medium of claim 13, wherein the servlet comprises a program running on a server that can be executed by another application running on the server.

25. An apparatus that executes a server page, comprising:
a receiving mechanism that is configured to receive a request at a servlet, wherein the request is triggered by a client making a reference through a uniform resource locator (URL);
a selection mechanism that is configured to select the server page to execute based upon the request, wherein the server page includes dynamically executable code embedded in a display language; and
an execution mechanism that is configured to execute the server page by using a method that is accessible within the servlet to execute the server page, so that after execution control automatically returns to the servlet;
wherein executing the server page causes a display page to be displayed on the client.

26. The apparatus of claim 25, wherein the execution mechanism is configured to:
compile the server page; and to
execute the compiled server page to generate the display page.

27. The apparatus of claim 26, wherein the execution mechanism is configured to facilitate a callback to the servlet in order to utilize state information maintained within the servlet.

28. The apparatus of claim 27, wherein the execution mechanism is configured to compute data to be injected into the display page.

29. The apparatus of claim 25, wherein the method that is accessible within the servlet is part of a template comprising a persistent object that defines the method.

30. The apparatus of claim 29, further comprising a separate template instance for each server page that is currently active within the servlet.

31. The apparatus of claim 25, wherein the execution mechanism is configured to facilitate executing the server page within a protected environment defined within the servlet.

32. The apparatus of claim 25, wherein the execution mechanism is configured to facilitate executing the server page outside of a space that the servlet is executed in.

33. The apparatus of claim 25, wherein the execution mechanism is configured to facilitate using multiple server pages to create a single display page.

34. The apparatus of claim 25, further comprising a servlet selection mechanism that is configured to:
receive the request from the client at a server;
select the servlet to execute based upon the request; and to
make the request to the servlet.

35. The apparatus of claim 25, wherein the server page includes one of:
a Java Server Page (JSP); and
an Active Server Page (ASP).

36. The apparatus of claim 25, wherein the servlet comprises a program running on a server that can be executed by another application running on the server.

37. A means for executing a server page, comprising:
a receiving means for receiving a request at a servlet, wherein the request is triggered by a client making a reference through a uniform resource locator (URL);
a selection means for selecting the server page to execute based upon the request, wherein the server page includes dynamically executable code embedded in a display language; and
an execution means for executing the server page by using a method that is accessible within the servlet to execute the server page, so that after execution control automatically returns to the servlet;
wherein executing the server page causes a display page to be displayed on the client.
